(19) United States
(12) Patent Application Publication
(10) Pub. No.: US 2006/0012653 A1
(43) Pub. Date: Jan. 19, 2006

(54) Metal complexes of azo dyes and their uses in ink-jet printing

(76) Inventors: Mairi Elizabeth Raggatt, Oxford (GB); Paul Wight, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 10/529,058

(22) PCT Filed: Sep. 4, 2003
(86) PCT No.: PCT/GB03/03812

§ 371 Date: Aug. 26, 2005

(30) Foreign Application Priority Data
Sep. 27, 2002 (GB) 0222494.7

(51) Int. Cl. G01D 11/00

(52) U.S. Cl. 347/100

(57) ABSTRACT

A compound of Formula (1) or a salt thereof: 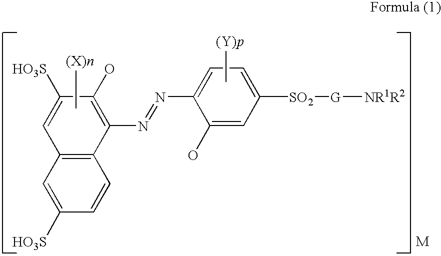 wherein: X and Y are each independently a substituent;
G is optionally substituted C₁₋₁₂-alkylene; M is a metal n is 0 to 6; p is 0 to 3;
R¹ is optionally substituted C₁₋₈-alkyl, optionally substituted C₅₋₈ cycloalkyl, optionally substituted aryl or an optionally substituted heterocycle; and
R² is H, or C₁₋₄-alkyl;
   provided that R¹ is free from carboxy groups. Also an ink-jet printing ink, an ink-jet printing process, a printed material and an ink jet printer cartridge.

This invention relates to compounds, to compositions containing these compounds, to inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate.

There are many demanding performance requirements for dyes and inks used in ink-jet printing. For example they desirably provide sharp, non-feathered images having good water, light and ozone fastness and optical density. The inks are often required to dry-quickly when applied to a substrate to prevent smudging, but they should not form a crust over the tip of an ink-jet nozzle because this will stop the printer from working. The inks should also be stable to storage over time without decomposing or forming a precipitate that could block the fine nozzle.

Copper chelate dyes are known from, for example, U.S. Pat. No. 6,265,554 B1. However, there is a continuing need to provide colorants having superior properties in ink-jet printing inks.

A particular problem for photorealistic quality printing is that of light-fastness. Prints are often exposed to daylight for long periods and there is a need for the image to have as good light-fastness as possible. The colorants in the print reacting with atmospheric ozone can play a major role in the fading of the dye.

This invention relates to magenta colorants suitable for use in ink-jet printing with improved light-fastness and to ink jet associated products and processes using these colourants.

According to the present invention there is provided a compound of Formula (1) or a salt thereof: 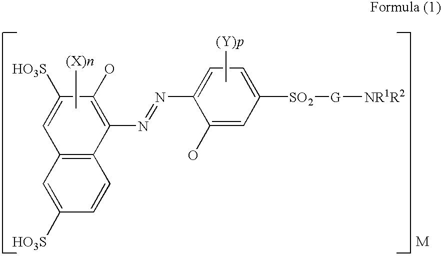
wherein:
X and Y are each independently a substituent;
G is optionally substituted C₁₋₁₂-alkylene;
M is a metal
n is 0 to 6;
p is 0 to 3;
R¹ is optionally substituted C₁₋₈-alkyl, optionally substituted C₅₋₈ cycloalkyl, optionally substituted aryl or optionally substituted heterocyclyl; and
R² is H, or C₁₋₄-alkyl;
   provided that R¹ is free from carboxy groups.

Preferably M is copper, more preferably M is Cu²⁺.

Compounds of Formula (1) may also comprise 1 or more additional ligands. These ligands may be coloured or colourless and when there is more than one ligand they may be the same or different. For example water may be a further ligand to M.

Preferably X and Y are each independently selected from: optionally substituted alkyl (preferably C₁₋₄-alkyl), optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (preferably phenyl), optionally substituted aryloxy (preferably phenoxy), optionally substituted heterocycyl, polyalkylene oxide (preferably polyethylene oxide or polypropylene oxide), carboxy, phosphato, sulpho, nitro, cyano, halo, ureido, —SO₂F, hydroxy, ester, —NR³R⁴, —COR³, —CONR³R⁴, —NHCOR³, carboxyester, sulphone, and —SO₂NR³R⁴ wherein R³ and R⁴ are each independently H or optionally substituted alkyl (especially C₁₋₄-alkyl) or, in the case of —CONR³R⁴ and —SO₂NR³R⁴, R³ and R⁴ together with the nitrogen atom to which they are attached may represent an aliphatic or aromatic ring system. Optional substituents for any of the substituents described for X and Y may be selected from the same list of substituents.

Preferably X is sulpho, hydroxy or amino.

Preferably Y is sulpho, amino, carboxy or phosphato.

G preferably is optionally substituted C₁₋₈-alkylene and more preferably optionally substituted C₁₋₄-alkyl, especially C₂₋₄-alkyl.

Optional substituents present on G are preferably selected from: optionally substituted alkenyl (preferably C₁₋₄-alkenyl), optionally substituted alkynyl (preferably C₁₋₄-alkynyl), optionally substituted alkoxy (preferably C₁₋₄-alkoxy), optionally substituted aryl (preferably phenyl), optionally substituted aryloxy (preferably phenoxy), optionally substituted heterocycyl, polyalkylene oxide (preferably polyethylene oxide or polypropylene oxide), carboxy, phosphato, sulpho, nitro, cyano, halo, ureido, —SO₂F, hydroxy, ester, —NR³R⁴, —COR³, —CONR³R⁴, —NHCOR³, carboxyester, sulphone, and —SO₂NR³R⁴, wherein R³ and R⁴ are as defined above. Optional substituents for any of the substituents described for G may be selected from the same list of substituents.

R¹ is preferably optionally substituted C₁₋₈alkyl, especially C₁₋₄-alkyl; optionally substituted phenyl or optionally substituted heterocycyl.

When R¹ is optionally substituted C₁₋₈-alkyl preferred substituents are selected independently from those listed above for G. When R¹ is optionally substituted C₁₋₈ alkyl it is especially preferred that R¹ is substituted with one or more groups selected from the group consisting of sulpho; phosphate; hydroxy; cyano, optionally substituted phenyl, especially phenylurea; optionally substituted heterocycyl, especially tetrahydrofuranyl.

When R¹ is optionally substituted phenyl or optionally substituted heterocycyl preferred substituents are selected independently from those listed above for X and Y.

R² is preferably H or methyl.

Acid or basic groups on the compounds of Formula (1), particularly acid groups, are preferably in the form of a salt. Thus, the Formulae shown herein include the compounds in free acid and in salt forms and in mixtures thereof.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines and mixtures thereof, more especially preferred salts are sodium salts. The compounds may be converted into salts using known techniques.

The compounds of Formula (1) may exist in tautomeric forms other than those shown in this specification. These tautomers are included within the scope of the present invention.

The metal complexes comprising compounds of Formula (1) have attractive, strong magenta shades and are valuable colorants for use in the preparation of ink-jet printing inks. They benefit from a good balance of solubility, storage stability and fastness to water and light. In particular they display excellent light and ozone fastness.

According to a second aspect of the present invention there is provided a composition comprising a compound of Formula (1) according to the first aspect of the invention and a medium, preferably a liquid medium.

Preferred compositions comprise:
(a) from 0.01 to 30 parts of a compound according to the first aspect of the invention; and
(b) from 70 to 99.99 parts of a liquid medium.

The number of parts of component (a) is preferably from 0.1 to 20, more preferably from 0.5 to 15, and especially from 1 to 5 parts. The number of parts of component (b) is preferably from 99.9 to 80, more preferably from 99.5 to 85, especially from 99 to 95 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

Preferred liquid media include water, a mixture of water and organic solvent and organic solvent free from water.

When the medium comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono- C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP 4,251,50A.

When the liquid medium comprises an organic solvent free from water, (i.e. less than 1% water by weight) the solvent preferably has a boiling point of from 30° to 200° C., more preferably of from 40° to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the compound in the liquid medium. Examples of polar solvents include C₁₋₄-alcohols.

In view of the foregoing preferences it is especially preferred that where the liquid medium is an organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the medium is an organic solvent free from water it is a mixture of 2 to 5 different organic solvents. This allows a medium to be selected that gives good control over the drying characteristics and storage stability of the ink.

Liquid media comprising an organic solvent free from water are particularly useful where fast drying times are required and particularly when printing onto hydrophobic and non-absorbent substrates, for example plastics, metal and glass.

The liquid media may also contain additional components conventionally used in ink jet printing inks, for example viscosity and surface tension modifiers, corrosion inhibitors, biocides, kogation reducing additives and surfactants which may be ionic or non-ionic.

Although not usually necessary, further colorants may be added to the composition to modify the shade and performance properties. Examples of such colorants include C.I.Direct Yellow 86, 132, 142 and 173; C.I.Direct Blue 199, and 307; C.I.Food Black 2; C.I.Direct Black 168 and 195; C.I.Acid Yellow 23; and any of the dyes used in ink jet printers sold by Seiko Epson Corporation, Hewlett Packard Company, Canon Inc. & Lexmark International. Addition of such further dyes can increase overall solubility leading to less kogation (nozzle blockage) for the resultant ink.

Preferably the composition according to the second aspect of the invention is an ink suitable for use in an inkjet printer or a liquid dye concentrate. Concentrates are useful as a means for transporting colorant and so minimising costs associated with drying the dye and transporting excess liquid.

Thus, compositions according to the second aspect of the invention are preferably prepared using high purity ingredients and/or by purifying the composition after it has been prepared. Suitable purification techniques are well known, e.g. ultrafiltration, reverse osmosis, ion exchange and combinations thereof (either before or after they are incorporated in a composition according to the present invention). This purification results in the removal of substantially all of the inorganic salts and by-products resulting from its synthesis. Such purification assists in the preparation of a low viscosity aqueous solution suitable for use in an ink jet printer.

Preferably the ink has a viscosity of less than 20 cP, more preferably less than 10 cP, especially less than 5 cP, at 25° C. These low viscosity inks are particularly well suited for application to substrates by means of ink jet printers.

Preferably the ink contains less than 500 ppm, more preferably less than 250 ppm, especially less than 100 pm, more especially less than 10 ppm in total of divalent and trivalent metal ions (other than any divalent and trivalent metal ions bound to a component of the ink). Free divalent and trivalent metals can form insoluble complexes on storage that could block the ink-jet printer nozzles.

Preferably the ink has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably the ink contains less than 500 ppm, more preferably less than 250 ppm, especially less than 100 pm, more especially less than 10 ppm in total of halide ions. High levels of halide ions can cause detrimental effects such as, for example, corrosion of metal parts in the ink-jet printer heads

A third aspect of the invention provides a process for forming an image on a substrate comprising applying an ink according to the second aspect of the invention thereto by means of an ink jet printer.

The ink-jet printer preferably applies the ink to the substrate in the form of droplets that are ejected through a small orifice onto the substrate. Preferred ink-jet printers are piezoelectric ink-jet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application 00/48938 and International Patent Application 00/55089.

The substrate is preferably paper, plastic, a textile, metal or glass, more preferably paper, an overhead projector slide or a textile material, especially paper.

Preferred papers are plain or treated papers which may have an acid, alkaline or neutral character.

Photographic ink-jet paper is an especially preferred substrate

A fourth aspect of the present invention provides paper, plastic, a textile, metal or glass or an overhead projector slide especially paper more especially plain, coated or treated papers printed with a composition according to the second aspect of the invention, a compound according to the first aspect of the invention or by means of a process according to third aspect of the invention.

It is especially preferred that the fourth aspect of the present invention is a photographic print on photographic quality ink-jet paper.

A fifth aspect of the present invention provides an ink jet printer cartridge comprising a chamber and an ink wherein the ink is in the chamber and the ink is as defined in the second aspect of the present invention.

The invention is further illustrated by the following Examples in which all parts and percentages are by weight unless otherwise stated.

### EXAMPLE 1

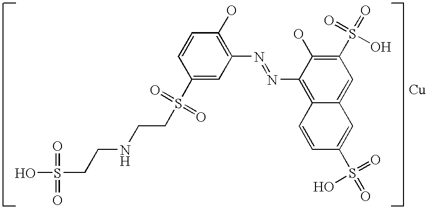

Taurine (7.8 g, 0.062 mol) was added to a solution of Reactive Red 23 (Duasyn™ Red 3B-SF-VP 346 from Clariant) (25 g, 0.031 mol) in water (300 ml). The reaction mixture was adjusted to pH 9 by the addition of 2N NaOH and stirred at 60° C. for 2 hours. The reaction mixture was then cooled to room temperature, the pH adjusted to 3 with concentrated HCl and the product precipitated by the addition of sodium chloride. The product was collected by filtration and dissolved in water (300 ml) and the pH adjusted to pH 7 with 48% NaOH. This solution was dialysed until the conductivity was less than 100 μs and then evaporated in an oven at 70° C. to give 19 g of a magenta solid.

### EXAMPLES 2 to 4

Examples 2 to 4 were prepared using an analogous process to that described in Example 1 except that in place of taurine the amino compounds shown in Table 1 were used to give compounds of general Formula (2) bearing the different X substituents shown in Table 1.

TABLE 1

| | |
|---|---|
| | Formula (2) |
| 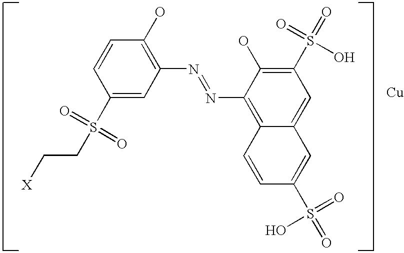 | |

| Example | Amino Compound | X |
|---|---|---|
| 2 | 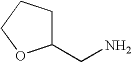 | 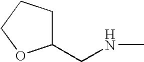 |
| 3 | 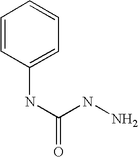 | 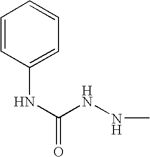 |
| 4 | 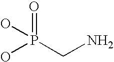 | 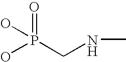 |

### COMPARATIVE EXAMPLE 1

Comparative Example 1 was prepared using an analogous process to that described in Example 1 except that the amino compound: 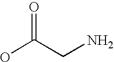
was used in place of taurine to give a compound of Formula (2) wherein X is:

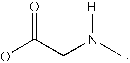

### EXAMPLE 5

Preparation of Inks 1 to 4 and Comparative Ink 1

Inks 1 to 4 were prepared by dissolving the corresponding compounds of Examples 1 to 4 (3.5 g) in 100 ml of a liquid medium consisting of 2-pyrrolidone/thiodiglycol/Surfynol™ 465 in a weight ratio of 5:5:1.

Comparative Ink 1 was prepared by dissolving the compound of Comparative Example 1 (3.5 g) in 100 ml of a liquid medium consisting of 2-pyrrolidone/thiodiglycol/Surfynol™ 465 in a weight ratio of 5:5:1.

### EXAMPLE 6

Ink-Jet Printing

Inks 1 to 4 and Comparative Ink 1 were ink-jet printed onto a variety of papers using a Hewlett Packard DeskJet 550C™. The CIE colour co-ordinates of each print (a, b, L, Chroma “C” and hue “h”) were measured using a Xrite 983™ Spectrodensitometer with 0°/45° measuring geometry with a spectral range of 400-700 nm at 20 nm spectral intervals, using illuminant C with a 2° (CIE 1931) observer angle and a density operation of status T. No less than 2 measurements were taken diagonally across a solid colour block on the print with a size greater than 10 mm×10 mm. The properties of the resultant prints of inks 1 to 4 are shown in Table 2.

TABLE 2
Ink Jet Print Properties

| | | % | | | | | |
|---|---|---|---|---|---|---|---|
| Ink | Paper | Depth | L | a | b | C | h |
| Ink 1 | Canon PR101 ™ | 100 | 49 | 65 | −2 | 65 | 358 |
| Ink 1 | Canon PR101 ™ | 50 | 63 | 53 | −7 | 54 | 352 |
| Ink 1 | Kodak | 100 | 45 | 60 | −3 | 60 | 357 |
| | Premium ™ | | | | | | |
| Ink 1 | Kodak | 50 | 57 | 57 | −10 | 58 | 350 |
| | Premium ™ | | | | | | |
| Ink 2 | Canon PR101 ™ | 100 | 45 | 66 | −13 | 67 | 349 |
| Ink 2 | Canon PR101 ™ | 50 | 60 | 55 | −15 | 57 | 344 |
| Ink 2 | Kodak | 100 | 42 | 59 | −9 | 60 | 351 |
| | Premium ™ | | | | | | |
| Ink 2 | Kodak | 50 | 54 | 58 | −15 | 60 | 346 |
| | Premium ™ | | | | | | |
| Ink 3 | Canon PR101 ™ | 100 | 51 | 67 | 3 | 67 | 3 |
| Ink 3 | Canon PR101 ™ | 50 | 64 | 55 | −6 | 56 | 354 |
| Ink 3 | Kodak | 100 | 46 | 61 | 1 | 61 | 1 |
| | Premium ™ | | | | | | |
| Ink 3 | Kodak | 50 | 58 | 57 | −7 | 57 | 353 |
| | Premium ™ | | | | | | |
| Ink 4 | Canon PR101 ™ | 100 | 47 | 68 | 3 | 68 | 2 |
| Ink 4 | Canon PR101 ™ | 50 | 60 | 60 | −6 | 61 | 355 |
| Ink 4 | Kodak | 100 | 39 | 49 | −10 | 50 | 349 |
| | Premium ™ | | | | | | |
| Ink 4 | Kodak | 50 | 53 | 51 | −13 | 53 | 346 |
| | Premium ™ | | | | | | |

Light Fastness

To evaluate light fastness the prints were irradiated in an Atlas Ci35 Weatherometer for 100 hours. The results are shown in Table 3 where degree of fade is expressed as ΔE where a lower figure indicates higher light fastness. ΔE is defined as the overall change in the CIE colour co-ordinates L*, a*, b* of the print and is expressed by the equation ΔE=(ΔL²+Δa²+Δb²)^{0.5}.

TABLE 3
Light Fastness

| Ink | Paper | ΔE |
|---|---|---|
| Ink 1 | Canon PR101 ™ | 4 |
| Ink 1 | Kodak Premium ™ | 6 |
| Ink 2 | Canon PR101 ™ | 7 |
| Ink 2 | Kodak Premium ™ | 9 |
| Ink 3 | Canon PR101 ™ | 9 |
| Ink 3 | Kodak Premium ™ | 10 |
| Ink 4 | Canon PR101 ™ | 10 |
| Ink 4 | Kodak Premium ™ | 12 |
| Comparative Ink | Canon PR101 ™ | 15 |
| Comparative Ink | Kodak Premium ™ | 14 |

From Table 3 it is clear that the inks of the present invention display an unexpected superior light fastness to those inks wherein R¹ contains a carboxy group.

Further Inks

The inks described in Tables A and B may be prepared wherein the Dye described in the first column is the compound made in the above Example of the same number. Numbers quoted in the second column onwards refer to the number of parts of the relevant ingredient and all parts are by weight. The inks may be applied to paper by ink-jet printing.

The following abbreviations are used in Tables A and B:
PG=propylene glycol
DEG=diethylene glycol
NMP=N-methylpyrollidone
DMK=dimethylketone
IPA=isopropanol
MEOH=methanol
2P=2-pyrrolidone
MIBK=methylisobutyl ketone
P12=propane-1,2-diol
BDL=butane-2,3-diol
CET=cetyl ammonium bromide
PHO=Na₂HPO₄ and
TBT=tertiary butanol

TDG=thiodiglycol

TABLE A

| Dye of | Dye | | | | | | | Na | | | | |
|---|---|---|---|---|---|---|---|---|---|---|---|---|
| Example | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 2 | 3.0 | 90 | | 5 | 5 | | 0.2 | | | | | |
| 3 | 10.0 | 85 | 3 | | 3 | 3 | | | | 5 | 1 | |
| 4 | 2.1 | 91 | | 8 | | | | | | | | 1 |
| 1 | 3.1 | 86 | 5 | | | | | 0.2 | 4 | | | 5 |
| 1 | 1.1 | 81 | | | 9 | | 0.5 | 0.5 | | | 9 | |
| 2 | 2.5 | 60 | 4 | 15 | 3 | 3 | | | 6 | 10 | 5 | 4 |
| 3 | 5 | 65 | | 20 | | | | | 10 | | | |
| 4 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 2 | 5.1 | 96 | | | | | | | | 4 | | |
| 1 | 10.8 | 90 | 5 | | | | | | 5 | | | |
| 2 | 10.0 | 80 | 2 | 6 | 2 | 5 | | | 1 | | 4 | |
| 3 | 1.8 | 80 | | 5 | | | | | | | 15 | |
| 4 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| 1 | 6.0 | 91 | | | 4 | | | | | | 5 | |

TABLE B

| Dye of | Dye | | | | | | | | | | | |
|---|---|---|---|---|---|---|---|---|---|---|---|---|
| Example | Content | Water | PG | DEG | NMP | CET | TBT | TDG | BDL | PHO | 2P | PI2 |
| 1 | 3.0 | 80 | 15 | | | 0.2 | | | | | 5 | |
| 2 | 9.0 | 90 | | 5 | | | | | | 1.2 | | 5 |
| 3 | 1.5 | 85 | 5 | 5 | | 0.15 | 5.0 | 0.2 | | | | |
| 4 | 2.5 | 90 | | 6 | 4 | | | | | 0.12 | | |
| 1 | 3.1 | 82 | 4 | 8 | | 0.3 | | | | | | 6 |
| 1 | 0.9 | 85 | | 10 | | | | | 5 | 0.2 | | |
| 2 | 8.0 | 90 | | 5 | 5 | | | 0.3 | | | | |
| 3 | 4.0 | 70 | | 10 | 4 | | | | 1 | | 4 | 11 |
| 4 | 2.2 | 75 | 4 | 10 | 3 | | | | 2 | | 6 | |
| 1 | 10.0 | 91 | | | 6 | | | | | | 3 | |
| 1 | 9.0 | 76 | | 9 | 7 | | 3.0 | | | 0.95 | 5 | |
| 1 | 5.0 | 78 | 5 | 11 | | | | | | | 6 | |
| 2 | 5.4 | 86 | | | 7 | | | | | | 7 | |
| 3 | 2.1 | 70 | 5 | 5 | 5 | 0.1 | 0.2 | 0.1 | 5 | 0.1 | 5 | |
| 4 | 2.0 | 90 | | 10 | | | | | | | | |
| 1 | 2 | 88 | | | | | | 10 | | | | |
| 1 | 5 | 78 | | | 5 | | | 12 | | | 5 | |
| 1 | 8 | 70 | 2 | | 8 | | | 15 | | | 5 | |
| 1 | 10 | 80 | | | | | | 8 | | | 12 | |
| 1 | 10 | 80 | | 10 | | | | | | | | |

1. A compound of Formula (1) or a salt thereof: 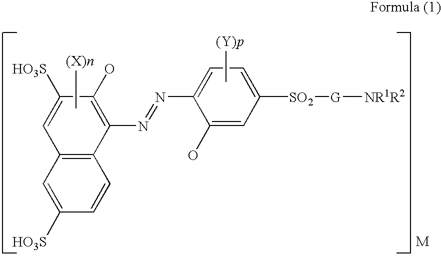
wherein:
X and Y are each independently a substituent;
G is optionally substituted C₁₋₁₂-alkylene;
M is a metal
n is 0 to 6;
p is 0 to 3;
R¹ is optionally substituted C₁₋₈-alkyl, optionally substituted C₅₋₈ cycloalkyl, optionally substituted aryl or an optionally substituted heterocycle; and
R² is H, or C₁₋₄-alkyl;
provided that R¹ is free from carboxy groups.

2. A compound according to claim 1 wherein M is Cu²⁺.

3. A compound according to either claim 1 or claim 2 wherein G is optionally substituted C₁₋₄-alkyl.

4. A compound according to either claim 1 or claim 2 wherein R¹ is optionally substituted C₁₋₈-alkyl, optionally substituted phenyl or an optionally substituted heterocycyl.

5. A compound according to either claim 1 or claim 2 wherein R² is H or methyl.

6. A composition comprising a compound as described in claim 1 and a liquid medium.

7. A composition according to claim 6 which is an ink suitable for use in an ink jet printer.

8. A process for forming an image on a substrate which comprises applying an ink as described in claim 7 thereto by means of an ink jet printer.

9. A paper, a plastic, a textile, metal or glass, or an overhead projector slide printed with a compound as described in claim 1.

10. An ink jet printer cartridge comprising a chamber and an ink wherein the ink is in the chamber and the ink is as defined in claim 7.
